(19) United States
(12) Patent Application Publication
(10) Pub. No.: US 2026/0290288 A1
(43) Pub. Date: Sep. 24, 2026

(54) INFORMATION PROCESSING APPARATUS, PERFORMANCE COMMENT SYSTEM, AND PERFORMANCE COMMENT METHOD

(71) Applicant: CASIO COMPUTER CO., LTD., Tokyo (JP)

(72) Inventor: Kotaro NAKASHIMA, Tokyo (JP)

(73) Assignee: CASIO COMPUTER CO., LTD., Tokyo (JP)

(21) Appl. No.: 19/570,914

(22) Filed: Mar. 18, 2026

(30) Foreign Application Priority Data
Mar. 19, 2025 (JP) 2025-044730

(51) Int. Cl. G10H 1/00; G06F 40/40; G10L 13/02

(52) U.S. Cl. CPC G10H 1/0008; G06F 40/40; G10L 13/02; G10H 2210/091

(57) ABSTRACT

An information processing apparatus includes: at least one of a microphone and a communication interface; and a processor, wherein the processor: sequentially acquires frames which are music data input from the outside through at least one of the microphone and the communication interface and in which the input music data is divided at set time intervals, and sequentially outputs comment data for the frames of the music data corresponding to at least one emotion label determined from among a plurality of emotion labels on the basis of the sequentially acquired divided frames.

### CROSS-REFERENCE TO RELATED APPLICATIONS

The present application claims priority under Paris Convention to Japanese Patent Application No. 2025-044730, filed on Mar. 19, 2025, the disclosure of which, including description, claims, abstract and drawings, is incorporated herein by reference in its entirety for all purposes.

### BACKGROUND

### Field

The present disclosure relates to an information processing apparatus, a performance comment system, and a performance comment method.

### Related Art

A chatbot that returns an answer to an input text is known (for example, JP 2025-22731 A).

### SUMMARY

An information processing apparatus according to an embodiment of the present disclosure includes: at least one of a microphone and a communication interface; and a processor, wherein the processor: sequentially acquires frames which are music data input from the outside through at least one of the microphone and the communication interface and in which the input music data is divided at set time intervals, and sequentially outputs comment data for the frames of the music data corresponding to at least one emotion label determined from among a plurality of emotion labels on the basis of the sequentially acquired divided frames.

### BRIEF DESCRIPTION OF THE DRAWINGS

FIG. 1 is a diagram illustrating a configuration of a system according to an embodiment of the present disclosure;

FIG. 2 is a block diagram illustrating a configuration of a server according to an embodiment of the present disclosure;

FIG. 3 is a diagram illustrating a flow of processing executed by a server in an embodiment of the present disclosure;

FIG. 4 is a diagram illustrating an example of a prompt provided to a text generation model in an embodiment of the present disclosure; and

FIG. 5 is a flowchart of processing executed by a server in an embodiment of the present disclosure.

### DETAILED DESCRIPTION OF EMBODIMENTS

The present disclosure relates to output of comment data reflecting emotions for music. In the present disclosure, a processor divides performance data generated in real time by performance by a user into frames at predetermined intervals, and reduces the amount of data processed at a time by the processor. The processor sequentially processes the frames of the divided performance data to reduce the processing load of the processor and enable real-time processing.

Furthermore, in the present disclosure, an audio recognition model sequentially determines emotion labels such as joy, anger, sorrow, and pleasure for performance data divided during performance by the user, and sequentially inputs a prompt including the determined emotion label in a template prepared in advance to the large language model, so that the processor sequentially generates comments on the performance of the user. As a result, the comments generated by the processor by the real-time processing during the performance of the user are sequentially fed back to the user. That is, according to the present disclosure, a certain amount of information such as performance data is reduced to a small amount of information such as an emotion label, and comments are sequentially generated using the emotion label. Therefore, a processing load of a computer is reduced, and real-time processing is enabled. Furthermore, the generated comments are sequentially output by speech synthesis at predetermined intervals. Therefore, a sentence amount of the comment to be generated is adjusted such that the sentence amount of the comment fits the speech corresponding to the comment within the predetermined interval. As a result, the processing load of the computer is reduced, and real-time processing is enabled. Note that the processor acquires musical sound data (music data) generated by the performance of the user via at least one of a microphone and a communication interface. The communication interface is a wired or wireless interface for acquiring external data.

The following description relates to an information processing apparatus, a system, a method, and a program according to an embodiment of the present disclosure. Common or corresponding elements are denoted by the same or similar reference numerals, and redundant description is simplified or omitted as appropriate. In each drawing, for convenience of description, the configuration is appropriately enlarged, reduced, or omitted. In order to improve the visibility of the drawings, the elements in the drawings may be indicated by lines other than solid lines (one-dot chain line, broken line, and the like) as necessary.

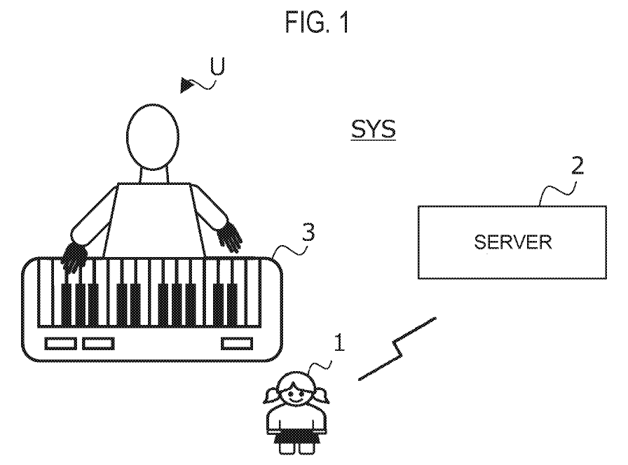

A system SYS illustrated in FIG. 1 includes a client 1 and a server 2. The client 1 includes a microphone and a speaker. The client 1 is, for example, a stuffed toy incorporating a computer equipped with a microphone and a speaker. The stuffed toy is, for example, a stuffed toy of a character A to be described later.

The client 1 may be a device of another form including a microphone and a speaker. The client 1 may be, for example, a smartphone, a personal computer (PC), or a tablet terminal. The client 1 may be a smart speaker (speaker having artificial intelligence (AI) assistant function corresponding to interactive speech manipulation).

The client 1 may be an article (for example, an electrical appliance such as a refrigerator or a washing machine, an ornament, or a toy) in which a smart speaker or a device similar to the smart speaker is built. The client 1 may be built in a performance apparatus 3.

In the example of FIG. 1, the performance apparatus 3 is an electronic keyboard. The performance apparatus 3 may be another form of electronic keyboard instrument such as an electronic piano. The performance apparatus 3 is not limited to the electronic keyboard instrument.

The performance apparatus 3 may be replaced with another form of performance apparatus such as an electronic string instrument, an electronic percussion instrument, or an electronic wind instrument. The performance apparatus 3 may be replaced with an acoustic instrument such as a piano or an acoustic guitar. The performance apparatus 3 may be an electronic device such as a drum pad. The performance apparatus 3 itself may be the client 1.

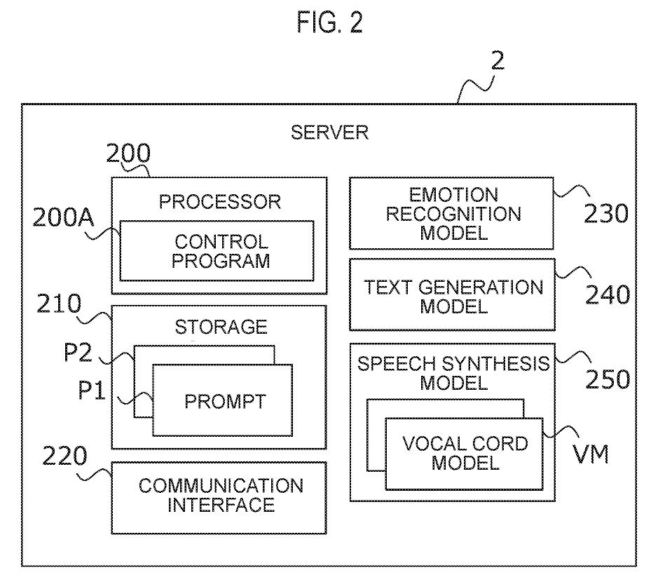

The server 2 is an example of a computer. As illustrated in FIG. 2, the server 2 includes a processor 200, a storage 210, a communication interface 220, an emotion recognition model 230, a text generation model 240, and a speech synthesis model 250. The processor 200 includes a central processing unit (CPU), a random access memory (RAM), a read only memory (ROM), and the like. The CPU is, for example, a single processor or a multiprocessor, and includes at least one processor. The CPU reads a program and data stored in the ROM. The CPU integrally controls the server 2 by using the RAM as a work area. The processor 200 (CPU) executes a control program 200A stored in the ROM to execute various processes according to an embodiment of the present disclosure. A part of the control by the processor 200 may be executed by a field programmable gate array (FPGA), an application specific integrated circuit (ASIC), or the like.

The storage 210 holds various data such as music data, text data, and audio data. The storage 210 is, for example, a hard disk drive (HDD) or a solid state drive (SSD). The communication interface 220 connects the server 2 to a communication network such as the Internet or a local area network (LAN). The server 2 communicates with, for example, the client 1 via the communication interface 220. For example, the processor 200 of the server 2 receives music data D2 (described later) from the client 1 and inputs the music data D2 to the emotion recognition model 230. Here, the client 1 performs control to divide the input music data D2 at a set interval (for example, in units of 10 seconds) and transmit the divided music data D2 to the server 2. As a result, the amount of data processed at a time by the processor 200 of the server 2 is reduced, so that the processing load of the processor 200 is reduced and the function of the server 2 is improved. In the present embodiment, an interval of 10 seconds is exemplified as the set interval, but the set interval may be an interval of 15 seconds or may be changed to an arbitrary interval at an arbitrary timing.

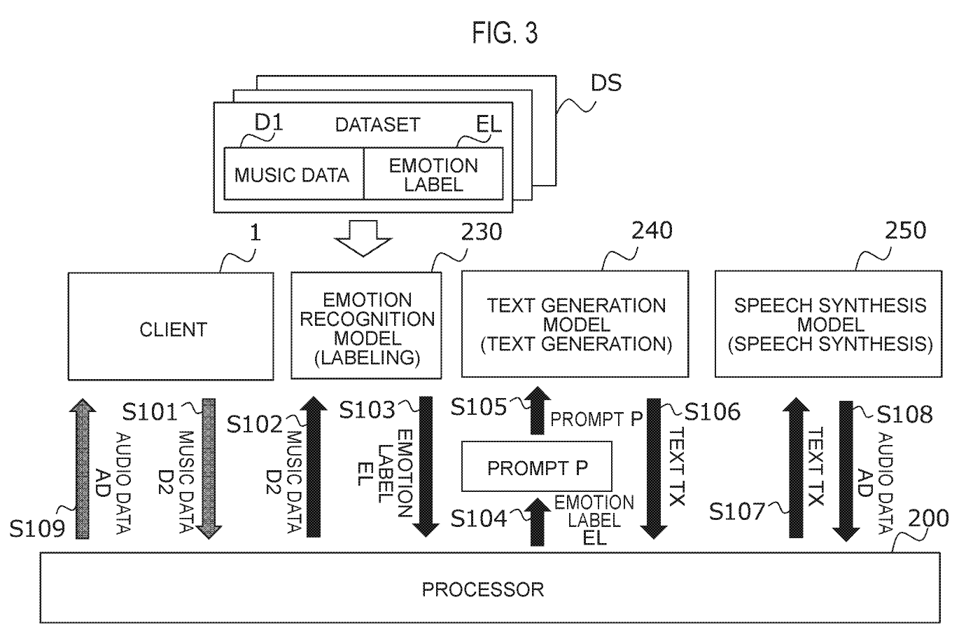

A flow of processing executed by the server 2 will be described with reference to FIG. 3. The emotion recognition model 230 is an example of a first learning model. The emotion recognition model 230 is a trained model obtained by fine tuning a predetermined audio recognition model on the basis of a dataset DS of an emotion label EL and music data D1 (an example of predetermined music data). The predetermined audio recognition model is, for example, an open source audio recognition model. Examples of the predetermined audio recognition model include wav2vec2.0 and MERT. That is, the emotion recognition model 230 is obtained by fine tuning an existing audio recognition model with the above-described dataset.

Any reference to elements using designations such as “first”, “second”, and the like as used in the present disclosure does not generally limit the amount or order of those elements. These designations are used for convenience to distinguish between two or more elements. Therefore, for example, reference to first and second elements does not mean that only the two elements may be adopted, the first element must precede the second element, or the like.

The order of the processing (steps) described in the embodiment of the present disclosure may be changed within a range without inconsistency. For example, in the embodiment of the present disclosure, various processes are presented using exemplary order, but the embodiment of the present disclosure is not limited to the presented order. In addition, the processes described in the embodiments of the present disclosure may be executed in parallel or concurrently within a range without inconsistency.

For example, in Russell's circumplex model of affect, the emotion of “anger” is arranged. When “anger” is set as one of the emotion labels EL, there is a high possibility that a line or a comment that is uncomfortable for the performer is returned as a response. For example, when a response such as “What a terrible piece! I started to feel angry!” is returned, the performer feels uncomfortable. Therefore, in the present embodiment, the emotion label EL is set around positive words so that a line or a comment comfortable for the performer is returned as a response. For example, as the emotion label EL, “pleasant”, “excited”, “fear”, “nervous”, “anxious”, “sad”, “poignant”, “relaxing”, “calm”, and “soothing” are set. That is, in order to prevent the emotion recognition model (trained model) 230 from outputting a negative word including “anger” as the emotion label EL, the negative emotion label EL including “anger” is not used as training data in the learning stage of the emotion recognition model (trained model) 230 in the present embodiment.

For convenience, in order to distinguish between music data for fine tuning (that is, the music data included in the dataset DS) and music data to be labeled, a symbol D1 is attached to the former music data and a symbol D2 is attached to the latter music data. The music data D2 to be labeled is, for example, data of a performance sound of the performance apparatus 3 by a user U and Musical Instrument Digital Interface (MIDI) data corresponding to the performance of the performance apparatus 3 by the user U. In the case of MIDI data, the client 1 and the performance apparatus 3 are connected in a wireless or wired manner so as to be able to perform MIDI communication. The data of the performance sound is, for example, audio data collected by the microphone of the client 1. The audio data is data in a file format such as RIFF waveform Audio Format (WAVE), Audio Interchange File Format (AIFF), MPEG-1 Audio Layer-3 (MP3), or Advanced Audio Coding (AAC). The client 1 uploads the acquired music data D2 to the server 2 at a set timing.

The music data D2 is not limited to data generated on the basis of performance, and may be audio data or MIDI data stored in the client 1 or a device different from the client 1. The other device mentioned here is, for example, a PC, a smartphone, a tablet terminal, a server, a cloud, a memory card, or the like. In this case, the client 1 uploads the music data D2 acquired from the other device to the server 2. The music data D2 may be, for example, data such as a piano roll input by Desktop Music (DTM) operating on the client 1 or the other device.

The client 1 acquires the music data D2 and transmits the acquired music data D2 to the server 2 (step S101). The processor 200 receives the music data D2 from the client 1 and inputs the music data D2 to the emotion recognition model 230 (step S102). The emotion recognition model 230 labels the input music data D2 (step S103). In other words, the emotion recognition model 230 outputs the emotion label EL corresponding to the input music data D2. Here, as the number of datasets DS given to the emotion recognition model 230 at the time of fine tuning increases, the labeling accuracy of the emotion recognition model 230 improves. On the other hand, as the number of datasets DS to be prepared increases, the work load for fine tuning increases. Therefore, in the present embodiment, in order to reduce the work load while ensuring the labeling accuracy, the number of datasets DS given to the emotion recognition model 230 at the time of fine tuning is suppressed to about 1000.

For example, the emotion recognition model 230 having different labeling accuracy for each grade of service to be provided may be prepared. The user U subscribing to a higher-grade service can use the emotion recognition model 230 with higher labeling accuracy. For example, the user U who subscribes to a higher-grade service can listen to lines and comments in which an appropriate emotion is reflected for a performed piece. As described above, the emotion label EL is set such that a line or a comment comfortable for the performer is returned as a response. Such an emotion label EL and improvement in labeling accuracy are combined to return comfortable lines and comments reflecting appropriate emotions for the performed piece. Therefore, the user U can play music while enjoying the mood. Since the user U feels happy, the motivation of playing itself also increases.

The emotion recognition model 230 acquires a low-dimensional representation (feature amount) of an audio signal by passing music data D2 received from the client 1 through a feature encoder, for example. The feature encoder is configured using, for example, a convolutional neural network (CNN). The feature encoder can capture temporal features of audio. The emotion recognition model 230 masks the output of the feature encoder in order to increase the comprehension level of the meaning and pattern of the audio. The emotion recognition model 230 applies a context network (for example, a transformer) to the output of the masked feature encoder and generates a probability distribution for each emotion label EL. The emotion recognition model 230 selects all the labels that satisfy the probability criteria. The emotion recognition model 230 outputs all the selected emotion labels EL. For example, the emotion recognition model 230 sequentially processes the music data D2 having a length equivalent to 10 seconds and outputs the emotion label EL. For example, in a case where the user U plays music with the performance apparatus 3, the emotion recognition model 230 outputs the emotion label EL for the performed piece every 10 seconds. The method of selecting the emotion label EL is not limited to the above. For example, the emotion recognition model 230 may select and output the emotion label EL having the highest probability. For example, the emotion recognition model 230 may select and output emotion labels EL up to the top n (n is a natural number of 2 or more).

In this manner, the server 2 acquires the music data D2, and determines at least one emotion label EL from among the plurality of emotion labels EL on the basis of the acquired music data D2. In addition, the server 2 inputs the acquired music data D2 to the emotion recognition model 230 (an example of the first learning model), and causes the emotion recognition model 230 to determine at least one emotion label EL from among the plurality of emotion labels EL. The server 2 can acquire information (that is, the emotion label EL) reflecting an emotion on music by using the fine-tuned emotion recognition model 230.

A plurality of prompts P including prompts P1 and P2 are stored in the storage 210. The prompt P is text data describing an instruction given to the text generation model 240 which is a generative AI. Each of the plurality of prompts P is associated with a respective vocal cord model VM having a different voice quality (boy, girl, and the like). That is, in the storage 210, the prompt P is stored in association with each vocal cord model VM having a different voice quality. The vocal cord model VM corresponding to each prompt P is held by the speech synthesis model 250.

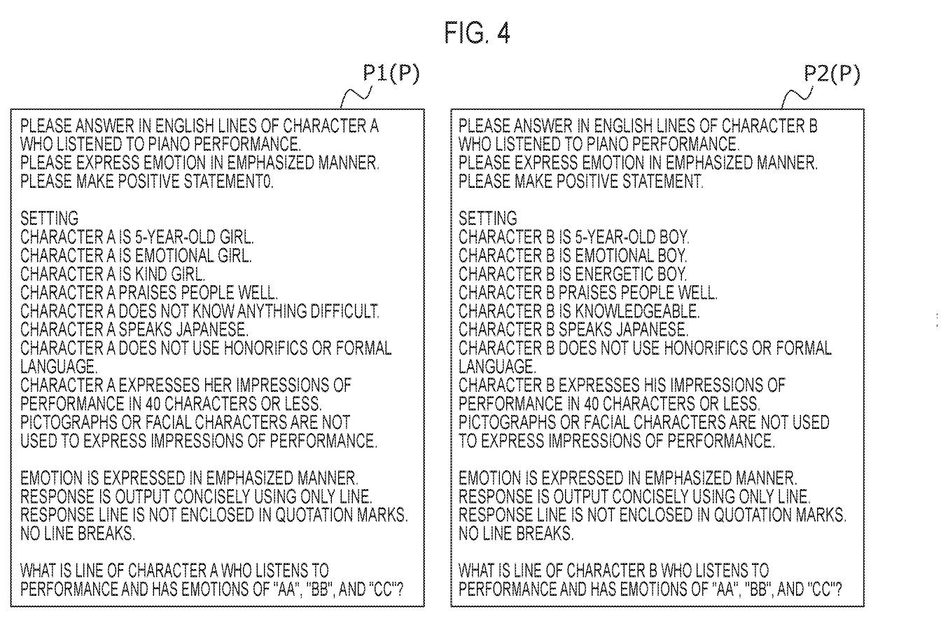

In FIG. 4, reference numerals P1 and P2 denote templates of prompts for the characters A and B, respectively. In the prompt P1, instructions for the character A such as “Please answer in English the lines of the character A who listened to the piano performance”, “Please express the emotion in an emphasized manner”, “Please make a positive statement”, and “What is the line of the character A who listens to the performance and has emotions of "AA”, “BB”, and “CC"?” are described. Emotion labels EL (“pleasant”, “excited”, and the like) are written in “AA”, “BB”, and “CC”. By including the plurality of emotion labels EL, since the type of the prompt P1 increases, there is an advantage that the type of answer by the text generation model 240 can also be expected to increase. In the prompt P1, settings of the character A such as “The character A is a 5-year-old girl”, “The character A is an emotional girl”, “The character A is a kind girl”, “The character A praises people well”, and “The character A does not know anything difficult” are described. In the prompt P2, instructions for the character B such as “Please answer in English the lines of the character B who listened to the piano performance”, “Please express the emotion in an emphasized manner”, “Please make a positive statement”, and “What is the line of the character B who listens to the performance and has emotions of "AA”, “BB”, and “CC"?” are described. In the prompt P2, the settings of the character B such as “The character B is a 5-year-old boy”, “The character B is an emotional boy”, “The character B is an energetic boy”, “The character B praises people well”, and “The character B is knowledgeable” are described. Emotion labels EL (“pleasant”, “excited”, and the like) are written in “AA”, “BB”, and “CC”. In the present embodiment, a prompt for instructing an answer in English is created, but an answer in any language including Japanese or Chinese may be instructed. Furthermore, in the present embodiment, the prompt is generated at set intervals, and the timing of generation corresponds to the timing of generation of the emotion label EL. Since the prompt is generated for each set interval, the amount of data processed at a time by the processor 200 of the server 2 can be reduced, the processing load of the processor 200 is reduced, and the function of the server 2 is improved.

The user U can designate a character by operating the client 1, for example. The processor 200 receives information on the character designated by the user operation from the client 1. The processor 200 sets a character according to the received information. The processor 200 writes the emotion label EL output from the emotion recognition model 230 in “AA”, “BB”, and “CC” of the prompt P corresponding to the set character (step S104). Note that “AA”, “BB”, and “CC” in FIG. 4 do not mean that the number of emotion labels EL to be written in the prompt P is fixed to three. For example, if there is one emotion label EL selected by the emotion recognition model 230, the one emotion label EL is written in the prompt P. For example, when there are four or more emotion labels EL selected by the emotion recognition model 230, all the four or more emotion labels EL are written in the prompt P.

For example, a case of writing the emotion label EL of “pleasant” or “excited” in the prompt P1 will be described. In this case, the instruction “What is the line of the character A who listens to the performance and has emotions of "AA”, “BB”, and “CC"?” is changed to an instruction “What is the line of the character A who listens to the performance and has emotions of "pleasant” and “excited"?”.

The text generation model 240 is a text generation AI, and is an example of a large language model (LLM). The text generation model 240 is, for example, an open source large language model. Examples of this type of model include GPT, Claude, and the like. The processor 200 inputs the prompt P in which the emotion label EL is written to the text generation model 240 (step S105).

The text generation model 240 generates and outputs a text TX expressing the emotion (such as “pleasant”) indicated by the emotion label EL written in the input prompt P (step S106). Exemplarily, the text generation model 240 performs pre-processing on the input prompt P. The text generation model 240 divides the pre-processed prompt P into tokens. The text generation model 240 encodes the tokenized prompt P. The text generation model 240 processes the encoded token with a transformer model. The text generation model 240 post-processes the token sequence obtained by the transformer model. The text generation model 240 outputs the post-processed token sequence (text TX). The text TX is an example of comment data for music data. The text TX includes lines and comments on music as content. More specifically, the text TX includes lines and comments reflecting emotions of models (character A, B, and the like) who listened to the music. The comment data may be paraphrased as, for example, “dialogue data”, “response data”, “emotion expression data”, “emotion reflection data”, or the like.

For example, a case where the text generation model 240 generates the text TX in accordance with the prompt P1 in which the emotion labels EL of “pleasant” and “excited” are written will be described. In this case, the text generation model 240 generates a text TX, for example, a text of wording or phrasing according to the settings of the character A (“The character A is a 5-year-old girl”, “The character A is an emotional girl”, and the like), and corresponding to the instruction (“What is the line of the character A who listens to the performance and has emotions of "pleasant” and “excited"?”, “Please express the emotion in an emphasized manner”, “Please make a positive statement”, and the like) of the prompt P1. As a more detailed example, the text generation model 240 generates a text TX (for example,...get excited and start dancing!...) that takes the meaning of the word of the emotion label EL written in the prompt P1.

The text generation model 240 generates the text TX every time the emotion label EL is input. For example, when the emotion label EL is input every 10 seconds, the text generation model 240 correspondingly outputs the text TX every 10 seconds.

In this manner, the server 2 generates the text TX corresponding to at least one emotion label EL. More specifically, the server 2 generates the prompt P based on the at least one emotion label EL. The server 2 inputs the generated prompt P to the text generation model 240 (an example of a large language model) to generate the text TX. In addition, the server 2 may select a prompt (for example, the prompt P1) from a plurality of prompts P and change the selected prompt P1 based on at least one emotion label EL. In the above example, the prompt P is changed by writing a word (for example, “pleasant”) of the emotion label EL in “AA” of the prompt P. The server 2 inputs the changed prompt P to the text generation model 240 to generate the text TX. Using the text generation model 240, the server 2 can generate a text TX expressing an emotion (for example, “pleasant”) corresponding to the emotion label EL.

For example, the text generation model 240 generates the text TX without reflecting the content of the past text TX. As a result, for example, it is possible to prevent generation of the text TX including unexpected contents. In another embodiment, the text generation model 240 may generate text TX that reflects the past text TX. In this case, the text generation model 240 can generate, for example, a line that takes over the emotion indicated by the immediately preceding text TX (for example, “You are more excited than before”).

The processor 200 inputs the text TX output from the text generation model 240 to the speech synthesis model 250 (step S107). At this time, the processor 200 notifies the speech synthesis model 250 of the prompt P (prompt P1, P2, and the like) given to the text generation model 240. The text TX output from the text generation model 240 may be directly input to the speech synthesis model 250 without passing through the processor 200.

The speech synthesis model 250 is a speech synthesis AI. The speech synthesis model 250 has been trained using various voice qualities and holds a plurality of vocal cord models VM having different voice qualities. In more detail, the speech synthesis model 250 holds a vocal cord model VM corresponding to each prompt P stored in the storage 210. That is, the speech synthesis model 250 holds a plurality of vocal cord models VM including the vocal cord model VM of the voice quality of the character A and the vocal cord model VM of the voice quality of the character B. Examples of the speech synthesis model 250 include WaveNet and VITS.

The speech synthesis model 250 converts the input text TX into audio data AD by using the vocal cord model VM corresponding to the prompt P notified by the processor 200 (step S108). For example, in the case of the prompt P1 notified by the processor 200, the speech synthesis model 250 calls the vocal cord model VM corresponding to the character A and converts the text TX into audio data AD reading out the text TX with the voice quality of the character A. The processor 200 transmits the audio data AD (in other words, the text TX converted into speech) converted by the speech synthesis model 250 to the client 1 (step S109).

The speech synthesis model 250 generates the audio data AD every time one text TX is input. For example, in a case where the text TX is input every 10 seconds, the speech synthesis model 250 correspondingly outputs the audio data AD every 10 seconds. For example, while the user U plays music with the performance apparatus 3, the server 2 transmits the audio data AD to the client 1 at intervals of 10 seconds. The client 1 sequentially outputs the audio data AD sequentially received from the server 2 from the speaker. For example, during performance of the performance apparatus 3, the user U can listen to lines and comments reflecting emotions for the performed piece. The lines and comments also change flexibly according to a change in tone during performance. The user U can play while enjoying listening to lines and comments reflecting emotions.

In the present embodiment, the content of the prompt P can be variously changed using one or plurality of emotion labels EL selected as appropriate (in other words, depending on the performance). Therefore, the contents (lines and comments) of the audio data AD returned from the server 2 can also vary in various ways. For example, the user U can continue listening to the lines and comments uttered from the client 1 without getting bored while continuing playing. For example, in order to listen to various lines and comments, the user U can also enjoy a way of playing by intentionally changing the tone during performance. For example, the user U can play various tones while enjoying such a way. As a result, the range of performance expression can be widened.

For example, even in a clumsy performance by a piano beginner, comfortable lines and comments are returned. Even a piano beginner can play music while feeling pleasant. Therefore, it is expected that the motivation of piano beginners to perform is increased. For example, from the viewpoint that comfortable lines and comments are returned by the favorite character, it is also expected that motivation of performance is increased from piano beginners to piano experts.

By switching the character (in other words, the prompt P), for example, the user U can listen to the lines and comments reflecting the emotions with his/her favorite words and phrases, and can also listen to the lines and comments reflecting the emotions with his/her favorite voice quality.

In this manner, the server 2 outputs the text TX corresponding to at least one emotion label EL determined from among the plurality of emotion labels EL as the audio data AD on the basis of the music data D2 acquired from the client 1. In addition, the server 2 causes the speech synthesis model 250 to generate the speech of the text TX on the basis of the vocal cord model VM associated with the prompt P selected by the user operation or the like.

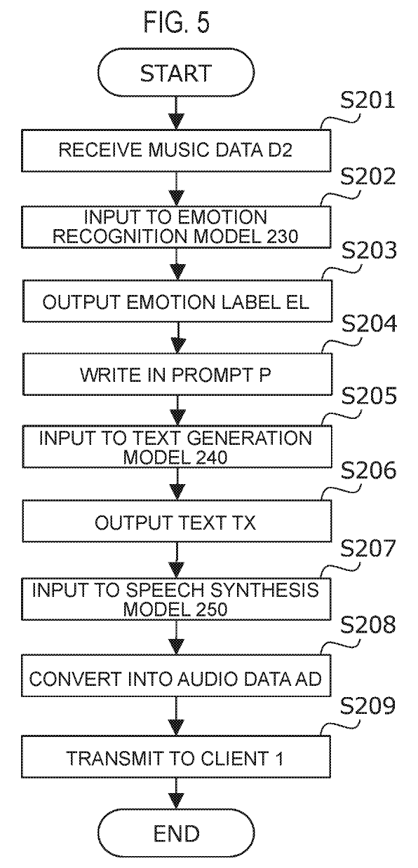

FIG. 5 is a flowchart of processing executed by the server 2. Steps S201 to S209 in FIG. 5 correspond to steps S101 to S109 in FIG. 3. Specifically, the server 2 receives the music data D2 transmitted from the client 1 (step S201). The processor 200 inputs the received music data D2 to the emotion recognition model 230 (step S202). The emotion recognition model 230 labels the input music data D2 (step S203). That is, the emotion recognition model 230 outputs the emotion label EL corresponding to the input music data D2.

As a comparative example, it is also conceivable to analyze the music data D2, score the correct/incorrect answer of the performance on the basis of the correct answer data as the example data corresponding to the input music data D2, and output the comment according to the scoring result. However, in the comparative example, for example, in a case where it is necessary for the processor of the server to determine which portion of which music the user plays, the search takes time and the determination takes time. In addition, in the comparative example, if there is no correct answer data as example data, the processor has a limited determination criterion, and it is difficult to generate a good prompt. In the present embodiment, the processor 200 performs control to output the emotion label EL on the basis of the input music data D2 and generate a prompt using the output emotion label EL. As a result, a functional improvement and a technical effect of the computer are provided, for example, making it possible to repeat the processing every short time such as 10 seconds.

The processor 200 writes the emotion label EL output from the emotion recognition model 230 in the prompt P (step S204). The processor 200 inputs the prompt P in which the emotion label EL is written to the text generation model 240 (step S205). The text generation model 240 generates and outputs a text TX expressing the emotion (such as “pleasant”) indicated by the emotion label EL written in the input prompt P (step S206).

The processor 200 inputs the text TX output from the text generation model 240 to the speech synthesis model 250 (step S207). At this time, the processor 200 notifies the speech synthesis model 250 of the prompt P given to the text generation model 240. The speech synthesis model 250 converts the input text TX into audio data AD by using the vocal cord model VM corresponding to the prompt P notified by the processor 200 (step S208). The processor 200 transmits the audio data AD converted by the speech synthesis model 250 to the client 1 (step S209). The client 1 sequentially outputs the audio data AD sequentially received from the server 2 from the speaker. For example, during performance of the performance apparatus 3, the user U can listen to lines and comments reflecting emotions for the performed piece.

The above description is a description of the exemplary embodiments of the present disclosure. The embodiments of the present disclosure are not limited to that described above, and various modifications can be made within the scope of the technical idea of the present disclosure. For example, the embodiments of the present disclosure also include contents obtained by appropriately combining the embodiments and the like exemplarily specified in the specification or obvious embodiments and the like.

In the above embodiment, each AI model of the emotion recognition model 230, the text generation model 240, and the speech synthesis model 250 is installed in the server 2. On the other hand, in another embodiment, each AI model may be installed in another server physically separated from the server 2. The three models may be installed in different servers. As described above, the configuration of the system SYS has a degree of freedom, and the configuration can be changed as appropriate.

In the above embodiment, the text TX is output as speech. On the other hand, in another embodiment, the text TX may be output as an image. In this case, the processor 200 transmits the text TX generated by the text generation model 240 to the client 1. The client 1 displays the text TX on its own screen or the like. In this case, since the text TX is not converted into speech, the speech synthesis model 250 is unnecessary. For example, during the performance of the performance apparatus 3, the user U can see lines and comments reflecting emotions for the performed piece.

In the above embodiment, the server 2 generates the audio data AD on the basis of the music data D2. On the other hand, in another embodiment, a locally installed terminal device may independently generate the audio data AD on the basis of the music data D2. In this case, the terminal device incorporates, for example, each block of the server 2 illustrated in FIG. 2. The terminal device is, for example, a stuffed toy incorporating a computer equipped with a microphone and a speaker. The terminal device may be, for example, a smartphone, a PC, a tablet terminal, a smart speaker, or an article (for example, an electrical appliance such as a refrigerator or a washing machine, an ornament, or a toy) incorporating a device similar thereto.

What is claimed is:

1. An information processing apparatus comprising:
at least one of a microphone and a communication interface; and
a processor, wherein
the processor:
sequentially acquires frames which are music data input from the outside through at least one of the microphone and the communication interface and in which the input music data is divided at set time intervals, and
sequentially outputs comment data for the frames of the music data corresponding to at least one emotion label determined from among a plurality of emotion labels on the basis of the sequentially acquired divided frames.

2. The information processing apparatus according to claim 1, wherein
the music data is generated in real time in response to a performance on an electronic musical instrument by a user, and
the comment data is sequentially output in real time during the performance on the electronic musical instrument by the user.

3. The information processing apparatus according to claim 1, wherein
the processor:
inputs the acquired music data to a first learning model, and
causes the first learning model to determine the at least one emotion label from among the plurality of emotion labels, and
the first learning model is a trained model obtained by fine tuning a predetermined audio recognition model on the basis of a dataset of the emotion label and predetermined music data.

4. The information processing apparatus according to claim 3, wherein
the first learning model generates a probability distribution for the plurality of emotion labels, and determines the at least one emotion label on the basis of a predetermined criterion.

5. The information processing apparatus according to claim 1, wherein
the processor:
writes the at least one emotion label into a template of a prompt, and
inputs the prompt with the at least one emotion label written into a large language model to generate the comment data representing the emotion label.

6. The information processing apparatus according to claim 1, wherein
the processor:
sequentially inputs the comment data to a speech synthesis model, and
causes the speech synthesis model to sequentially generate a speech of the comment data.

7. A performance comment system comprising:
a client; and a server, wherein
the client:
acquires frames of music data divided at a set time interval, and
sequentially transmits the acquired frames of the divided music data to the server,
the server:
sequentially determines at least one emotion label from among a plurality of emotion labels on the basis of the frames of the divided music data received from the client,
sequentially generates comment data for the frames of the music data corresponding to the determined at least one emotion label, and
sequentially transmits the generated comment data to the client, and
the client sequentially outputs the comment data received from the server.

8. The performance comment system according to claim 7, wherein
the music data is generated in real time in response to a performance on an electronic musical instrument by a user, and
the comment data is sequentially output in real time during the performance on the electronic musical instrument by the user.

9. A performance comment method, wherein
a processor of an information processing apparatus sequentially acquires frames which are music data input from the outside through at least one of a microphone and a communication interface of the information processing apparatus and in which the input music data is divided at set time intervals, and
the processor sequentially outputs comment data for the frames of the music data corresponding to at least one emotion label determined from among a plurality of emotion labels on the basis of the sequentially acquired divided frames.

10. The performance comment method according to claim 9, wherein
the music data is generated in real time in response to a performance on an electronic musical instrument by a user, and
the comment data is sequentially output in real time during the performance on the electronic musical instrument by the user.

11. The performance comment method according to claim 9, wherein
the processor:
inputs the acquired music data to a first learning model, and
causes the first learning model to determine the at least one emotion label from among the plurality of emotion labels, and
the first learning model is a trained model obtained by fine tuning a predetermined audio recognition model on the basis of a dataset of the emotion label and predetermined music data.

12. The performance comment method according to claim 11, wherein
the first learning model generates a probability distribution for the plurality of emotion labels, and determines the at least one emotion label on the basis of a predetermined criterion.

13. The performance comment method according to claim 9, wherein
the processor:
writes the at least one emotion label into a template of a prompt, and
inputs the prompt with the at least one emotion label written into a large language model to generate the comment data representing the emotion label.

14. The information processing apparatus according to claim 9, wherein
the processor:
sequentially inputs the comment data to a speech synthesis model, and
causes the speech synthesis model to sequentially generate a speech of the comment data.
